(19) United States
(12) Patent Application Publication
(10) Pub. No.: US 2026/0316706 A1
(43) Pub. Date: Oct. 15, 2026

(54) OFF-ROAD VEHICLE

(71) Applicant: KAWASAKI MOTORS, LTD., Akashi-shi (JP)

(72) Inventor: Akihiro FUKUMOTO, Akashi-shi (JP)

(73) Assignee: KAWASAKI MOTORS, LTD., Akashi-shi (JP)

(21) Appl. No.: 19/640,428

(22) Filed: Apr. 7, 2026

(30) Foreign Application Priority Data
Apr. 14, 2025 (JP) 2025-066349

(51) Int. Cl. B60R 16/04; B60N 2/005; B60R 13/08; B60R 16/033; H01M 50/249

(52) U.S. Cl. CPC B60R 16/04; B60R 13/08; B60R 16/033; H01M 50/249; B60N 2/005; H01M 2220/20

(57) ABSTRACT

A short circuit between a battery and a body frame is prevented or reduced. A utility vehicle includes a seat located on a floor, a battery located on the floor, a body frame including an upper frame located above the battery, an insulator located between the upper frame and a battery post of the battery.

### CROSS-REFERENCE TO RELATED APPLICATION

This application claims priority to Japanese Patent Application No. 2025-066349 filed on Apr. 14, 2025, the disclosure of which including the specification, the drawings, and the claims is hereby incorporated by reference in its entirety.

### FIELD

The technique disclosed here relates to an off-road vehicle.

### BACKGROUND

U.S. Pat. No. 11,097,607 discloses an automobile including a seat supported by a seat frame, and a battery located below the seat. The seat frame is partially located above the battery.

### SUMMARY

In replacing a battery, for example, a user needs to use a tool to attach and detach a metal fitting that is to be attached to a battery post of the battery. In this case, the battery post is located on the upper surface of a battery body, and therefore, the user performs work on the battery post basically from above the battery. Accordingly, during the work on the battery post, the tool is likely to contact a body frame located above the battery. If the tool contacts the body frame during the work on the battery post, the battery and the body frame might be short-circuited via the tool.

It is therefore an object of the technique disclosed here to prevent or reduce a short circuit between a battery and a body frame.

An off-road vehicle disclose herein includes: a seat located on a floor; a battery located on the floor; a body frame including an upper frame located above the battery; and an insulator located between the upper frame and a battery post of the battery.

The off-road vehicle can prevent or reduce a short circuit between the battery and the body frame.

### BRIEF DESCRIPTION OF THE DRAWINGS

FIG. 1 is a side view of a utility vehicle.

FIG. 2 is a perspective view of a rear seat portion of the utility vehicle, as seen from the left front.

FIG. 3 is a perspective view of the utility vehicle with a seat cushion removed, as seen from the left front.

FIG. 4 is a perspective view of a rear seat and a battery, as seen from the lower left.

FIG. 5 is a perspective view of an upper frame, an insulator, and the battery, as seen from the upper left.

FIG. 6 is a view of the battery, the upper frame, and the insulator, as seen from above.

FIG. 7 is a view of upper portions of the upper frame, the insulator, and the battery, as seen from the left.

FIG. 8 is a perspective view of a positive post, as seen obliquely from above.

### DETAILED DESCRIPTION

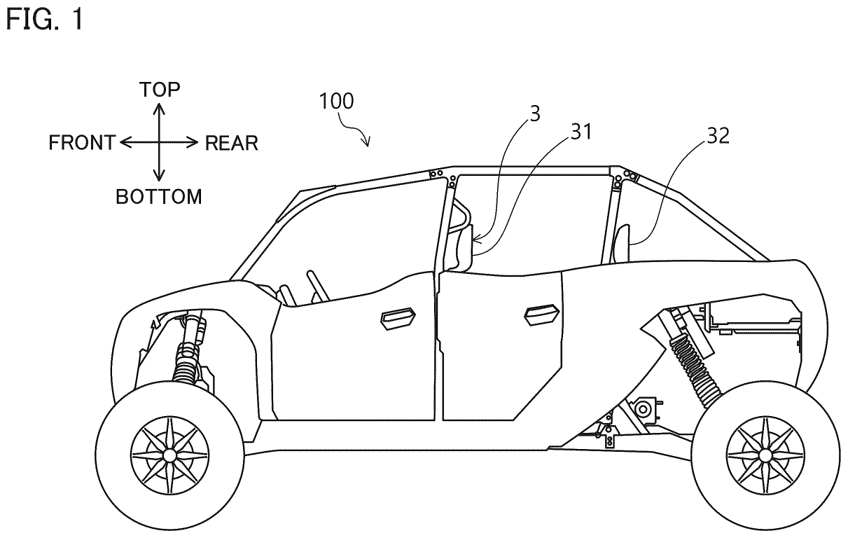

An exemplary embodiment will be described in detail hereinafter with reference to the drawings. FIG. 1 is a side view of a utility vehicle 100. The utility vehicle 100 is a four-wheeled vehicle that can travel off-road. The utility vehicle 100 is an example of an off-road vehicle. Hereinafter, the utility vehicle 100 will also be referred to simply as a “vehicle 100.”

In this disclosure, components of the vehicle 100 will be described based on directions of the vehicle 100. Specifically, “front” refers to the front of the vehicle 100 in the front-rear direction, and “rear” refers to the rear of the vehicle 100 in the front-rear direction. “Left” refers to the left of the vehicle 100 when seeing forward, and “right” refers to the right of the vehicle 100 when seeing forward. The “vehicle width direction” refers to the vehicle width direction of the vehicle 100, and will be sometimes referred to as a “left-right direction.” The expression “a member extends or expands in a direction” herein includes not only a case where the member extends or expands strictly in parallel with the direction” but also a case where the member extends or expands generally in the direction.”

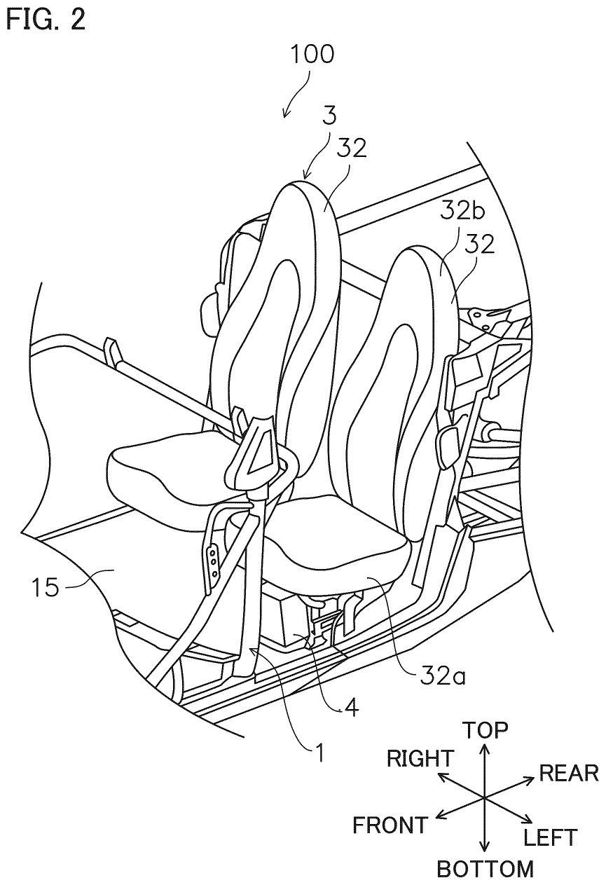

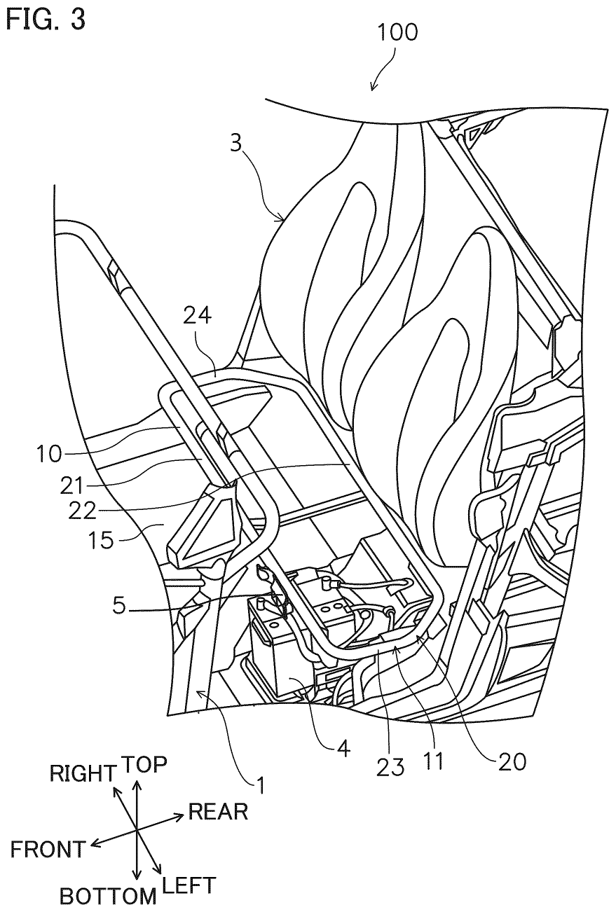

FIG. 2 is a perspective view of a rear seat portion of the vehicle 100, as seen from the left front. FIG. 3 is a perspective view of the vehicle 100 with a seat cushion removed, as seen from the left front. In FIGS. 2 and 3, members such as a door are omitted.

As illustrated in FIG. 2, the vehicle 100 includes a seat 3, a battery 4, a body frame 1, and an insulator 5. The insulator 5 is illustrated in FIG. 3.

The seat 3 is located on a floor 15. The floor 15 defines the bottom of a cabin. The floor 15 expands in the front-rear directions and the vehicle width directions as a whole.

As illustrated in FIG. 1, the seat 3 may include a front seat 31 and a rear seat 32 located rearward of the front seat 31. That is, the vehicle 100 may be a vehicle with two rows of seats. In FIG. 2, the front seat 31 is omitted and the rear seat 32 is shown. Each of the front seat 31 and the rear seat 32 includes a seat cushion that supports the buttocks of a passenger and a seat back that supports the back of the passenger. FIG. 2 shows a seat cushion 32a and a seat back 32b of the rear seat 32. The seat 3 may include a pair of left and right front seats 31. The seat 3 may include a pair of left and right rear seats 32.

As illustrated in FIG. 3, the body frame 1 is a frame structure serving as a framework of the vehicle 100. The body frame 1 is made of, for example, a metal. The body frame 1 may include frames.

The body frame 1 may include a seat frame 11 supporting the seat 3. The seat frame 11 is made of, for example, a metal. The seat frame 11 may include a first frame 21, a second frame 22, a third frame 23, and a fourth frame 24.

Each of the first frame 21 and the second frame 22 extends generally in the vehicle width direction. Each of the third frame 23 and the fourth frame 24 extends generally in the front-rear direction. Strictly speaking, a rear portion of each of the third frame 23 and the fourth frame 24 is bent inward in the vehicle width direction. The second frame 22 is located rearward of the first frame 21. The third frame 23 is located leftward of the center in the vehicle width direction. The fourth frame 24 is located rightward of the center in the vehicle width direction. The right end of the first frame 21 is coupled to the front end of the fourth frame 24. The left end of the first frame 21 is coupled to the front end of the third frame 23. The right end of the second frame 22 is coupled to the rear end of the fourth frame 24. The left end of the second frame 22 is coupled to the rear end of the third frame 23. In the following description, when the first frame 21, the second frame 22, the third frame 23, and the fourth frame 24 are not distinguished, these frames are referred to simply as a “frame 20.”

The frame 20 is located above the floor 15 by a predetermined distance. That is, a gap in the top-bottom direction is defined between the floor 15 and the rear seat 32 (see FIG. 2). The battery 4 may be located in this gap.

The body frame 1 includes an upper frame 10 located above the battery 4. In this disclosure, the expression “located above” refers only to the position in the top-bottom direction, without considering positions in the vehicle width direction and in the front-rear direction. In the vehicle 100, the upper frame 10 is located directly above the battery 4. That is, the upper frame 10 is located above the battery 4 and overlaps the battery 4 in a plan view.

The upper frame 10 may be at least a portion of the seat frame 11. For example, the upper frame 10 is the first frame 21 that is a portion of the seat frame 11.

The upper frame 10 may extend in a direction that intersects with the front-rear direction. Hereinafter, the direction in which the upper frame 10 extends will be referred to as a “extension direction.” For example, the extension direction of the upper frame 10 may substantially coincide with the vehicle width direction. The upper frame 10 may be linear.

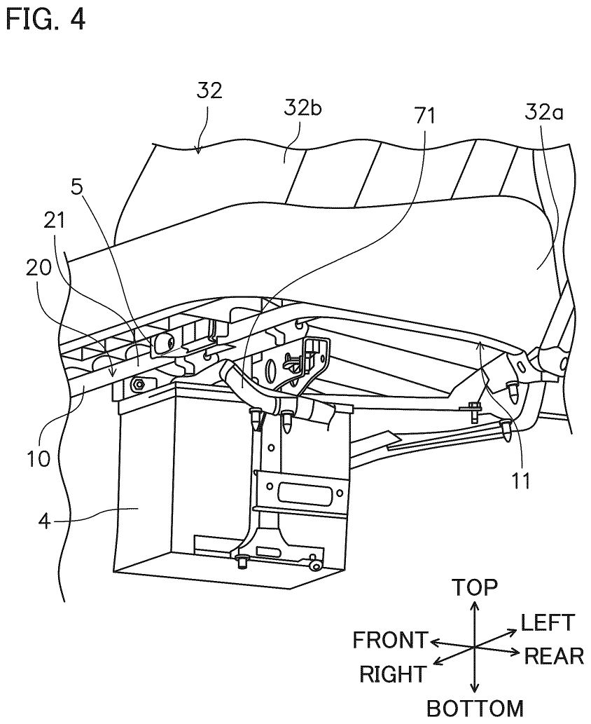

FIG. 4 is a perspective view of the rear seat 32 and the battery 4, as seen from the lower left. In FIG. 4, the floor 15 is omitted. The seat cushion 32a of the rear seat 32 is placed on the frame 20 of the seat frame 11 and is detachably attached to the frame 20, for example. Accordingly, the seat cushion 32a of the rear seat 32 is supported by the seat frame 11.

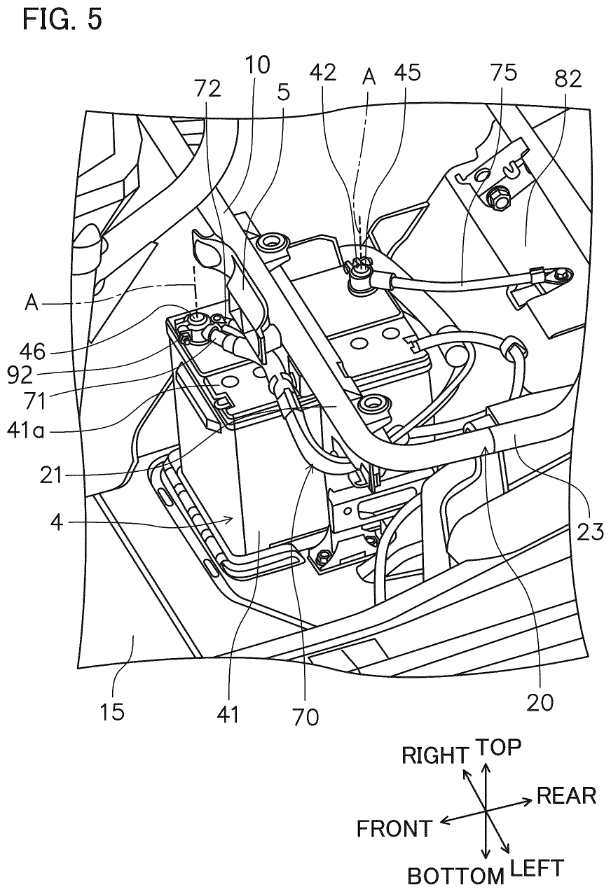

FIG. 5 is a perspective view of the upper frame 10, the insulator 5, and the battery 4, as seen from the upper left. In FIG. 5, the seat cushion 32a of the rear seat 32 is omitted. The battery 4 is a supply source of electric power necessary for the vehicle 100. The battery 4 supplies electric power to electric components.

The battery 4 is located on the floor 15. As illustrated in FIG. 4, the battery 4 may be located below the seat 3, specifically the seat cushion 32a. For example, the entire battery 4 overlaps the seat cushion 32a in a plan view. For example, the battery 4 is located leftward of the center in the vehicle width direction. The battery 4 may be fixed to, for example, the floor 15 or the body frame 1.

As illustrated in FIG. 5, the battery 4 may include a battery body 41 and a battery post 42.

The shape of the battery body 41 is, for example, substantially a rectangular parallelepiped. In this example, the longitudinal direction of the battery body 41 generally coincides with the front-rear direction. The lateral direction of the battery body 41 substantially coincides with the vehicle width direction. The height direction of the battery body 41 generally coincides with the top-bottom direction.

The battery post 42 is a columnar component serving as an external terminal of the battery 4. The battery post 42 may project upward from an upper surface 41a of the battery body 41. That is, an axis A of the battery post 42 may extend generally in the top-bottom direction.

The battery post 42 may include a negative post 45 and a positive post 46. The negative post 45 is a battery post serving as a negative terminal of the battery 4. The positive post 46 is a battery post serving as a positive terminal of the battery 4.

The negative post 45 is grounded. The negative post 45 may be grounded while being connected to a vehicle body panel 82 via an earth cable 75.

Cables 70 that transport electric power to electric components are connected to the positive post 46. The cables 70 may include a first cable 71 and a second cable 72.

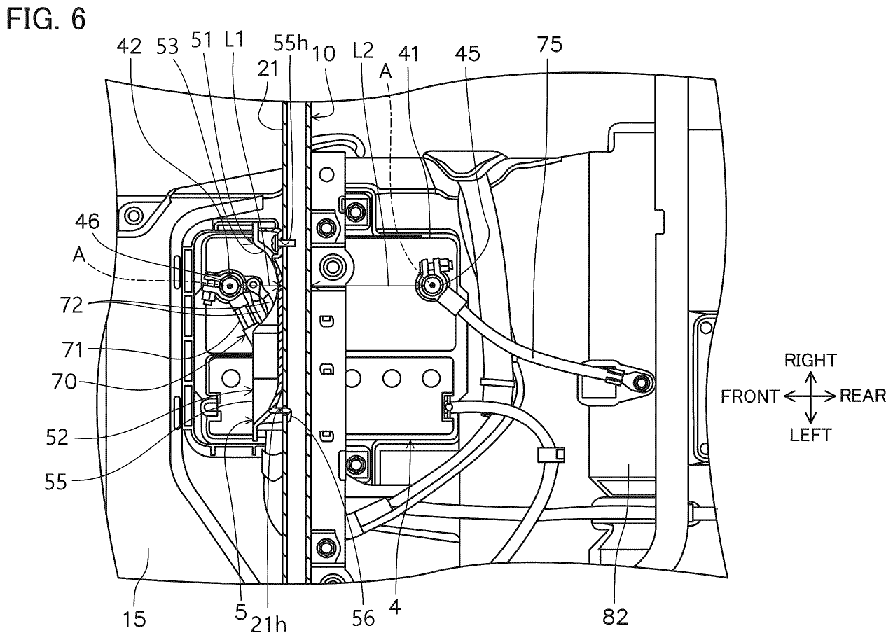

FIG. 6 is a view of the battery 4, the upper frame 10, and the insulator 5, as seen from above. In FIG. 6, the upper frame 10 and the insulator 5 are cut along a horizontal plane. The battery post 42 may be offset from the upper frame 10 in a plan view. That is, the battery post 42 may be displaced in a direction away from the upper frame 10 in a plan view. For example, the battery post 42 may be offset forward or rearward from the upper frame 10 in a plan view.

The upper frame 10 may be located between the negative post 45 and the positive post 46 in a plan view. For example, the negative post 45 may be offset rearward from the upper frame 10 in a plan view. For example, the positive post 46 may be offset forward from the upper frame 10 in a plan view.

A distance L1 between the positive post 46 and the upper frame 10 in the front-rear direction may be smaller than a distance L2 between the negative post 45 and the upper frame 10 in the front-rear direction. The negative post 45 and the positive post 46 may be arranged generally in the front-rear direction.

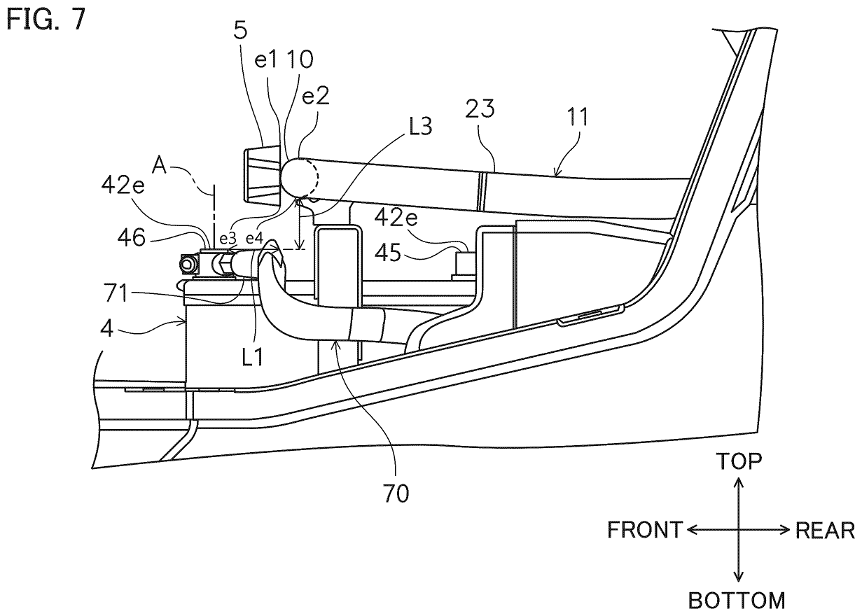

FIG. 7 is a perspective view of upper portions of the upper frame 10, the insulator 5, and the battery 4, as seen from the left. A height position of an upper end 42e of the battery post 42 may be lower than a height position of a lower end e4 of the upper frame 10. Specifically, a height position of an upper end 42e of the positive post 46 may be lower than a height position of a lower end e4 of the upper frame 10. A height position of an upper end 42e of the negative post 45 may be lower than the height position of the lower end e4 of the upper frame 10.

A distance L3 between the positive post 46 and the upper frame 10 in the top-bottom direction may be substantially the same as or smaller than the distance L1 between the positive post 46 and the upper frame 10 in the front-rear direction. In the vehicle 100, the distance L3 is substantially the same as the distance L1. As described above, the distance L1 may be smaller than the distance L2 between the negative post 45 and the upper frame 10 in the front-rear direction. That is, the distance L1 and the distance L3 may be smaller than the distance L2. In this manner, the upper frame 10 may be located at a position relatively close to the positive post 46.

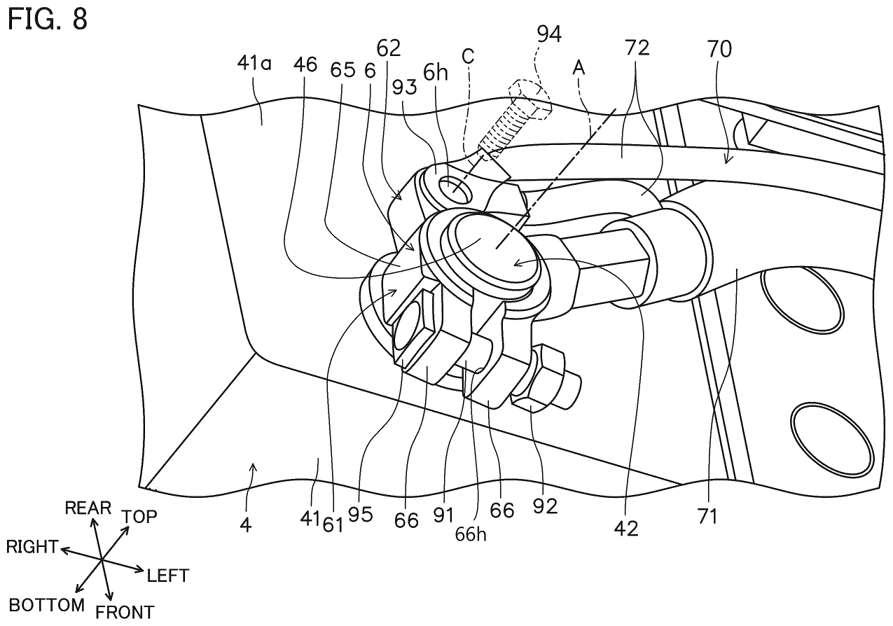

FIG. 8 is a perspective view of the positive post 46, as seen obliquely from above. The vehicle 100 may further include a battery terminal 6 connected to an end portion of the first cable 71 and attached to the battery post 42. The battery terminal 6 is a component that connects the cables 70 to the battery post 42. The battery terminal 6 is detachably attached to the battery post 42. In this example, the battery terminal 6 is integrated with the first cable 71.

The battery terminal 6 may include a terminal body 61 and a projection 62. The terminal body 61 may include a fastening ring 65 and a pair of fastening pieces 66.

The fastening ring 65 is attached to the positive post 46 to surround the outer circumference of the positive post 46. The shape of the fastening ring 65 is a circular arc surrounding the outer circumference of the positive post 46.

The shape of each of the fastening pieces 66 is a plate shape. One of the pair of fastening pieces 66 projects outward in a radial direction about the axis A (hereinafter referred to simply as a “radial direction” or “radially”) from a first end of the fastening ring 65 in the circumferential direction about the axis A (hereinafter referred to simply as a “circumferential direction”). The other fastening piece 66 projects radially outward from a second end of the fastening ring 65 in the circumferential direction.

Each of the fastening pieces 66 includes a through hole 66h penetrating the fastening piece 66. A bolt 91 is inserted into the through hole 66h. The bolt 91 has a head 95 in an axial end portion of the bolt 91. The head 95 is retained with the fastening ring 65. A nut 92 is screwed onto the other axial end portion of the bolt 91. The nut 92 is offset from the positive post 46 on one side in the extension direction. For example, the nut 92 is offset from the positive post 46 outward in the vehicle width direction. By using a tool such as a wrench to tighten the nut 92 onto the bolt 91, the distance between the pair of fastening pieces 66 decreases, thereby reducing the diameter of the fastening ring 65. In this manner, the fastening rings 65 fasten the positive post 46 so that the terminal body 61 is attached to the positive post 46. As illustrated in FIG. 5, for example, the fastening ring 65 is attached to the positive post 46 such that the axial direction of the bolt 91 generally extends in the vehicle width direction. The head 95 is located inward of the nut 92 in the vehicle width direction.

As illustrated in FIG. 8, the projection 62 connects the second cable 72 to the positive post 46. The projection 62 may project radially outward of the outer peripheral surface of the fastening ring 65. Specifically, the projection 62 may project radially outward from a portion of the outer peripheral surface of the fastening ring 65 on the side opposite to the pair of fastening pieces 66 with respect to the axis A.

The battery terminal 6 may include an attachment hole 6h to which the second cable 72 is attached. Specifically, the projection 62 may include the attachment hole 6h. The attachment hole 6h is, for example, a screw hole. For example, the bolt 94 or the like is inserted through the through hole of a washer 93 attached to an end portion of the second cable 72, and the bolt 94 is screwed into the attachment hole 6h so that the second cable 72 is thereby attached to the battery terminal 6.

An axis C of the attachment hole 6h may extend in the top-bottom direction. That is, work on the bolt 94 that is screwed into the attachment hole 6h may be performed from above.

As illustrated in FIG. 7, in performing work on the battery post 42 using a tool such as a wrench, the insulator 5 prevents or reduces a short circuit between the battery 4 and the body frame 1 via the tool. Examples of the work on the battery post 42 include attachment/detachment work of the battery terminal 6 to/from the positive post 46 and attachment/detachment work of the second cable 72 to/from the battery terminal 6. A material for the insulator 5 is not particularly limited as long as the material is an electrically insulating material. For example, the material for the insulator 5 is a resin or rubber.

The insulator 5 is located between the upper frame 10 and the battery post 42 of the battery 4. For example, the insulator 5 is located between the positive post 46 and the upper frame 10.

As illustrated in FIG. 6, the insulator 5 may be located between the upper frame 10 and the battery post 42 in a plan view. In this example, the insulator 5 is located between the upper frame 10 and the positive post 46 in a plan view.

At least a portion of the insulator 5 may be located forward of the upper frame 10 in a plan view. In this example, the entire insulator 5 is located forward of the upper frame 10 in a plan view. That is, in this example, the insulator 5 is not located above, below, or rearward of the upper frame 10.

The insulator 5 may extend along the extension direction of the upper frame 10. For example, the insulator 5 extends generally in the vehicle width direction.

The insulator 5 may be attached to the upper frame 10. For example, the insulator 5 may include a through hole 55h located on one side in the extension direction with respect to the battery post 42, and an engagement piece 56 located on the other side in the extension direction with respect to the battery post 42. The through hole 55h is an example of a first attachment portion. The engagement piece 56 is an example of a second attachment portion. The insulator 5 may be attached to the upper frame 10 via the through hole 55h and the engagement piece 56. In this example, “one side in the extension direction” is an inner side in the vehicle width direction, and “the other side in the extension direction” is an outer side in the vehicle width direction.

The insulator 5 may be attached to a front surface of the upper frame 10 via the through hole 55h and the engagement piece 56. In this example, the insulator 5 is attached only to the front surface of the upper frame 10. That is, in this example, the insulator 5 is not attached to any of an upper surface, a lower surface, and a rear surface of the upper frame 10.

For example, the insulator 5 includes a body 55 extending along the extension direction. The through hole 55h is located at one end portion on one side of the body 55 in the extension direction and passes through the body 55. The engagement piece 56 is located at an end portion on the other side of the body 55 in the extension direction and projects from the body 55 toward the upper portion frame 10. The engagement piece 56 is inserted into the engagement hole 21h in the upper frame 10, and is engaged with the upper frame 10. In the state where the engagement piece 56 and the upper frame 10 are engaged, a screw is inserted into the through hole 55h and screwed into the screw hole of the upper frame 10. In this manner, the insulator 5 is attached to the upper frame 10.

In the insulator 5, the second portion 52 located on the other side in the extension direction with respect to the battery post 42 may be longer than the first portion 51 located on one side in the extension direction with respect to the battery post 42. That is, the center of the insulator 5 in the extension direction may be displaced to the other side in the extension direction (e.g., outward in the vehicle width direction) with respect to the battery post 42.

As illustrated in FIG. 7, a height position of an upper end e1 of the insulator 5 may be higher than a height position of an upper end e2 of the upper frame 10. A height position of a lower end e3 of the insulator 5 may be lower than the height position of the lower end e4 of the upper frame 10. Specifically, the height position of the upper end e1 of the insulator 5 may be higher than a height position of an upper end e2 of a portion of the upper frame 10 overlapping the insulator 5 (hereinafter referred to simply as an “overlapping portion”). The height position of the lower end e3 of the insulator 5 may be lower than a lower end e4 of the overlapping portion. That is, the insulator 5 may overlap the whole or a most part of the overlapping portion, as seen in a direction orthogonal to both the extension direction and the top-bottom direction.

As illustrated in FIG. 6, the insulator 5 may include a recess 53 that is recessed from the battery post 42 toward the upper frame 10 in a plan view. For example, the recess 53 is recessed from the positive post 46 toward the first frame 21 in a plan view. That is, the recess 53 is recessed from the positive post 46 toward the first frame 21 in the entire height direction of the insulator 5. Regarding the position in the extension direction, the position of the recess 53 may overlap the position of the positive post 46.

The recess 53 may be recessed in an arc shape in a plan view. Regarding the position in the extension direction, the position of the positive post 46 may substantially coincide with the center position of the arc of the recess 53 in a plan view.

Next, an example of replacement work of the battery 4 will be described with reference to FIGS. 5 and 8. First, a user detaches the earth cable 75 from the negative post 45. Accordingly, the grounding is canceled. Thereafter, the user removes the bolt 94 screwed into the attachment hole 6h of the battery terminal 6, using a tool such as a wrench. Accordingly, the second cable 72 is detached from the battery terminal 6. Thereafter, the user removes the nut 92 from the bolt 91 using a tool such as a wrench. Accordingly, tightening of the fastening ring 65 on the positive post 46 is weakened, causing the battery terminal 6 and the first cable 71 to be detached from the positive post 46. Subsequently, the user removes the battery 4 from the floor 15 and replaces the battery 4 with a new battery 4. The connection method for various cables to the new battery 4 is the reverse of the aforementioned work, and thus, detailed description will be omitted.

Here, as described above, the user needs to first remove the earth cable 75 from the negative post 45 to cancel the grounding. However, there may be a case where work of the next process is performed while the earth cable 75 is attached to the negative post 45, that is, while the battery 4 is grounded. In this case, when the tool contacts the upper frame 10 during removal work of the bolt 94 or the nut 92, the battery 4 and the upper frame 10 might be short circuited via the tool. Specifically, in the removal work of the bolt 94, the user performs the work on the bolt 94 basically from above. At this time, a tool such as a wrench is arranged generally along the top-bottom direction, and rotates about the axis of the bolt 94 with the tip of the tool serving as a fulcrum. Therefore, when the rear end of the tool moves toward the upper frame 10, when the tool might contact the upper frame 10. In the removal work of the nut 92, the user also performs the work on the nut 92 basically from above. At this time, a tool such as a wrench is arranged generally along the top-bottom direction, and rotates about the axis of the bolt 91 with the tip of the tool serving as a fulcrum. That is, the rear end of the tool can move in the front-rear direction in a plan view. Thus, when the rear end of the tool moves rearward, the tool might contact the upper frame 10. The vehicle 100 includes the insulator 5, and even if the tool approaches the upper frame 10 during the aforementioned work, the tool contacts the insulator 5, thereby avoiding or reducing contact between the tool and the upper frame 10. This prevents or reduces a short circuit between the battery 4 and the upper frame 10.

The space below the seat 3 can be a dead space. The battery 4 is located in the dead space below the seat 3. In such a configuration, the seat frame 11 is located above the battery 4, increasing the possibility that the tool contacts the seat frame 11 during the aforementioned work. In the vehicle 100, since the insulator 5 is located between the seat frame 11 and the battery post 42, contact between the tool and the seat frame 11 is avoided or reduced, and a short circuit between the battery 4 and the seat frame 11 is prevented or reduced. That is, it is possible to prevent or reduce a short circuit between the battery 4 and the seat frame 11 while effectively utilizing the dead space below the seat 3.

The insulator 5 is attached to the upper frame 10. This allows the insulator 5 to be kept away from the battery post 42, thereby ensuring a work space in performing work on the battery post 42 with a tool.

Since the battery post 42 is offset from the upper frame 10 in a plan view, work on the battery post 42 can be easily performed from above. In addition, since the insulator 5 is located between the upper frame 10 and the battery post 42 in a plan view, even if the tool tilts toward the upper frame 10 in performing work on the battery post 42 from above, contact of the tool with the upper frame 10 is prevented or reduced.

The battery post 42 is offset forward or rearward from the upper frame 10 in a plan view. Accordingly, work on the battery post 42 can be easily performed from above.

The upper frame 10 is located between the negative post 45 and the positive post 46, and the insulator 5 is located between the positive post 46 and the upper frame 10. In the work on the negative post 45, a short circuit is less likely to occur via the tool. On the other hand, in the work on the positive post 46, a short circuit might occur via the tool. Since the insulator 5 is located between the positive post 46 and the upper frame 10, a short circuits via the tool can be effectively prevented or reduced.

The positive post 46 is offset forward from the upper frame 10 in a plan view, and the negative post 45 is offset rearward from the upper frame 10 in a plan view. In this situation, in the case of performing work on the positive post 46 from above using a tool, when the tool tilts rearward from the position of the positive post 46, the tool is likely to contact the upper frame 10. Since at least a portion of the insulator 5 is located forward of the upper frame 10 in a plan view, even when the tool tilts rearward from the position of the positive post 46, contact between the tool and the upper frame 10 can be effectively prevented or reduced. Furthermore, when the tool tilts rearward from the position of the positive post 46, the tool is likely to contact the front surface of the upper frame 10. In this example, since the insulator 5 is attached to the front surface of the upper frame 10, contact between the tool and the front surface of the upper frame 10 can be effectively prevented or reduced.

The height position of the upper end e1 of the insulator 5 is higher than the height position of the upper end e2 of the upper frame 10, and the height position of the lower end e3 of the insulator 5 is lower than the height position of the lower end e4 of the upper frame 10. Accordingly, even when the tool approaches the upper frame 10 from above or from below, the insulator 5 can easily prevent or reduce contact of the tool with the upper frame 10. Consequently, a short circuit between the battery 4 and the body frame 1 via the tool is effectively prevented or reduced.

The height position of the upper end 42e of the battery post 42 is lower than the height position of the lower end e4 of the upper frame 10. This allows the battery 4 and the upper frame 10 to be separated from each other in the top-bottom direction so that the battery 4 can be easily moved during, for example, replacement of the battery 4.

In some cases, in performing work on the battery post 42 using a tool, the tool interferes with the insulator 5, and the insulator 5 may become an obstacle. In this example, the insulator 5 includes the recess 53 that is recessed from the battery post 42 toward the upper frame 10 in a plan view. This allows the tool to be moved by also using the space inside the recess 53. Consequently, interference between the insulator 5 and the tool is avoided or reduced, and workability is enhanced.

In performing work on the battery post 42 using a tool, the tool may rotate with the tip of the tool serving as a fulcrum. Since the recess 53 is recessed in an arc shape in a plan view, interference between the tool and the insulator 5 is further prevented or reduced, and workability is further enhanced.

In the insulator 5, the second portion 52 located on the other side in the extension direction with respect to the battery post 42 is longer than the first portion 51 located on one side in the extension direction with respect to the battery post 42. Accordingly, by placing the nut 92 on the other side in the extension direction with respect to the battery post 42, it is possible to perform, for example, the replacement work of the battery 4 while avoiding or reducing a short circuit via the tool.

In maintenance of the battery 4, the user often performs work from the outer side in the vehicle width direction. Since the other side in the extension direction is the outer side in the vehicle width direction, the user can perform the replacement work of the battery 4 and other work while clearly observing the nut 92.

The insulator 5 includes the through hole 55h located on one side in the extension direction with respect to the battery post 42 and the engagement piece 56 located on the other side in the extension direction with respect to the battery post 42, and is attached to the upper frame 10 via the through hole 55h and the engagement piece 56. This allows the user to perform removal work of the insulator 5 while keeping the tool away from the battery post 42 during work such as removal work of the insulator 5 using a tool in maintenance of the insulator 5. Consequently, a short circuit caused by contact of the tool with the battery post 42 can be prevented or reduced.

The axis C of the attachment hole 6h to which the second cable 72 is attached extends in the top-bottom direction. Accordingly, the user can easily perform the attachment/detachment work of the second cable 72 on the battery terminal 6 from above.

### Other Embodiments

In the foregoing description, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

For example, the off-road vehicle is not limited to the utility vehicle 100. The off-road vehicle may be, for example, an all terrain vehicle (ATV), a tractor, or other vehicles. The off-road vehicle is not limited to the four-wheeled vehicle, and may be a three-wheeled vehicle, for example.

The configuration of the seat 3 is not limited to the configuration of the embodiment described above. For example, the seat 3 may not include the seat back. The seat 3 may be a three-row seat.

The configuration of the body frame 1 is not limited to the configuration of the embodiment described above. The upper frame 10 is not limited to the first frame 21. The upper frame 10 may not be at least a portion of the seat frame 11. The shape, layout, number, and other characteristics of the upper frame 10 are not limited. For example, the upper frame 10 may extend in the front-rear direction or in a direction inclined from the horizontal direction. The upper frame 10 may not be linear and may be bent. The upper frame 10 may not overlap the battery 4 in a plan view. The number of the upper frames 10 may be two or more.

The upper frame 10 may not be located between the negative post 45 and the positive post 46 in a plan view. For example, the upper frame 10 may be located forward or rearward of both the negative post 45 and the positive post 46.

The configuration, layout, and number of the battery 4 are not limited to the configuration, layout, and number in the embodiment described above. For example, the battery 4 may be located below the front seat 31 or may be located rightward of the center in the vehicle width direction. The battery 4 may not be located below the seat 3. The number of batteries 4 may be two or more.

The layout of the battery post 42 is not limited. For example, the positive post 46 may be offset rearward from the upper frame 10 in a plan view, and the negative post 45 may be offset forward from the upper frame 10 in a plan view. At least one of the negative post 45 or the positive post 46 may be located directly under the upper frame 10. That is, at least one of the negative post 45 or the positive post 46 may overlap the upper frame 10 in a plan view.

The configuration of the battery terminal 6 is not limited to the configuration of the embodiment described above. For example, the battery terminal 6 may not include the projection 62. The battery terminal 6 may not be integrated with the first cable 71. For example, the first cable 71 may be detachably attached to the battery terminal 6. The axis C of the attachment hole 6h may not extend in the top-bottom direction.

The shape, layout, number, and other characteristics of the insulator 5 are not limited. For example, the recess 53 of the insulator 5 may not be recessed in an arc shape in a plan view. The insulator 5 may not include the recess 53. The length of the first portion 51 of the insulator 5 in the extension direction may be equal to the length of the second portion 52 in the extension direction, or may be longer than the length of the second portion 52 in the extension direction. The height position of the upper end e1 of the insulator 5 may be approximately the same as the height position of the upper end e2 of the upper frame 10, or may be lower than the height position of the upper end e2 of the upper frame 10. The height position of the lower end e3 of the insulator 5 may be approximately the same as the height position of the lower end e4 of the upper frame 10, or may be higher than the height position of the lower end e4 of the upper frame 10.

The insulator 5 may not be attached to the front surface of the upper frame 10 and may be attached to any position on the surface of the upper frame 10 as long as the insulator 5 is located between the battery post 42 and the upper frame 10. The insulator 5 may not be located between the upper frame 10 and the battery post 42 in a plan view. In this embodiment, the number of insulators 5 is one, but may be two or more.

The attachment structure of the insulator 5 to the upper frame 10 is not limited to the attachment structure of the embodiment described above. For example, the insulator 5 may be attached to the upper frame 10 using fasteners such as screws in the second portion 52, similarly to the first portion 51. The insulator 5 may not be attached to the upper frame 10 via the through hole 55h and the engagement piece 56. For example, the insulator 5 may be attached to the upper frame 10 only via the through hole 55h.

The material for the insulator 5 is not limited as long as the material has electrical insulation.

The insulator 5 may be a coating film on the upper frame 10. In this case, the coating film may have a relatively large thickness to prevent or reduce a short circuit between the battery post 42 and the upper frame 10.

The insulator 5 may not be attached to the upper frame 10 as long as the insulator 5 is located between the battery post 42 and the upper frame 10. For example, the insulator 5 may be an insulating cover that covers the battery 4. In this case, the insulating cover may have a through hole at a position corresponding to the battery post 42. The user may perform work on the battery post 42 through the through hole.

### ASPECT

The embodiment described above are a specific example of the following aspects.

### Aspect 1

A utility vehicle 100 (off-road vehicle) includes: a seat 3 located on a floor 15; a battery 4 located on the floor 15; a body frame 1 including an upper frame 10, the upper frame 10 being located above the battery 4; and an insulator 5 located between the upper frame 10 and a battery post 42 of the battery 4.

In this configuration, since the insulator 5 is located between the upper frame 10 and the battery post 42 of the battery 4, in performing work on the battery post 42 using a tool, even when the tool approaches the upper frame 10, the tool contacts the insulator 5 so that contact between the tool and the upper frame 10 is avoided or reduced. As a result, a short circuit between the battery 4 and the body frame 1 is prevented or reduced.

### Aspect 2

In the utility vehicle 100 of Aspect 1, the battery 4 is located below the seat 3, and the upper frame 10 is at least a portion of a seat frame 11 supporting the seat 3.

This configuration can prevent or reduce a short circuit between the battery 4 and the seat frame 11 while effectively using a dead space below the seat 3.

### Aspect 3

In the utility vehicle 100 of Aspect 1 or 2, the insulator 5 is attached to the upper frame 10.

In this configuration, the insulator 5 is kept away from the battery post 42 so that a work space in performing work on the battery post 42 using a tool can be obtained.

### Aspect 4

In the utility vehicle 100 of any one of Aspects 1 to 3, the battery post 42 is offset from the upper frame 10 in a plan view, and the insulator 5 is located between the upper frame 10 and the battery post 42 in a plan view.

In this configuration, the battery post 42 is offset from the upper frame 10 in a plan view, and thus, work on the battery post can be easily performed from above. In addition, since the insulator 5 is located between the upper frame 10 and the battery post 42 in a plan view, even when the tool tilts toward the upper frame 10 in performing work on the battery post 42 from above, contact of the tool with the upper frame 10 can be prevented or reduced.

### Aspect 5

In the utility vehicle 100 of any one of Aspects 1 to 4, the battery post 42 is offset forward or rearward from the upper frame 10 in a plan view.

This configuration allows work on the battery post 42 to be easily performed from above.

### Aspect 6

In the utility vehicle 100 of any one of Aspects 1 to 5, the battery post 42 includes a negative post 45 and a positive post 46, the negative post 45 serving as a negative terminal of the battery 4, the positive post 46 serving as a positive terminal of the battery 4, the upper frame 10 is located between the negative post 45 and the positive post 46 in a plan view, and the insulator 5 is located between the positive post 46 and the upper frame 10.

In work on the negative post 45, a short circuit via a tool is less likely to occur. On the other hand, in work on the positive post 46, a short circuit might occur via the tool. In this configuration, since the insulator 5 is located between the positive post 46 and the upper frame 10, a short circuit via the tool is effectively prevented or reduced.

### Aspect 7

In the utility vehicle 100 of any one of Aspects 1 to 6, the positive post 46 is offset forward from the upper frame 10 in a plan view, the negative post 45 is offset rearward from the upper frame 10 in a plan view, and at least a portion of the insulator 5 is located forward of the upper frame 10.

In the case of performing work on the positive post 46 from above using a tool, when the tool tilts rearward from the position of the positive post 46, the tool is likely to contact the upper frame 10. In this configuration, since at least a portion of the insulator 5 is located forward of the upper frame 10 in a plan view, even when the tool tilts rearward from the position of the positive post 46, contact between the tool and the upper frame 10 can be effectively prevented or reduced.

### Aspect 8

In the utility vehicle 100 of any one of Aspects 1 to 7, a height position of an upper end e1 of the insulator 5 is higher than a height position of an upper end e2 of the upper frame 1, and a height position of a lower end e3 of the insulator 5 is lower than a height position of a lower end e4 of the upper frame 10.

In this configuration, even when the tool approaches the upper frame 10 from above or from below, the insulator 5 can easily prevent or reduce contact of the tool with the upper frame 10. Consequently, a short circuit between the battery 4 and the body frame 1 via the tool is effectively prevented or reduced.

### Aspect 9

In the utility vehicle 100 of any one of Aspects 1 to 8, a height position of an upper end 42e of the battery post 42 is lower than a height position of a lower end e4 of the upper frame 10.

This configuration allows the battery 4 and the upper frame 10 to be separated from each other in the top-bottom direction so that the battery 4 can be easily moved during, for example, replacement of the battery 4.

### Aspect 10

In the utility vehicle 100 of any one of Aspects 1 to 9, the insulator 5 includes a recess 53 that is recessed from the battery post 42 toward the upper frame 10 in a plan view.

In some cases, in performing work on the battery post 42 using a tool, the insulator 5 interferes with the tool, and the insulator 5 may become an obstacle. In this configuration, the user can also utilize the space inside the recess 53 to move the tool, thereby avoiding or reducing interference between the insulator 5 and the tool, and enhancing workability.

### Aspect 11

In the utility vehicle 100 of any one of Aspects 1 to 10, the recess 53 is recessed in an arc shape in a plan view.

In performing work on the battery post 42 using a tool, the tool can rotate with the tip of the tool serving as a fulcrum. In this configuration, interference between the tool and the insulator 5 is further prevented or reduced, and workability is further enhanced.

### Aspect 12

In the utility vehicle 100 of any one of Aspects 1 to 11, the insulator 5 extends along an extension direction of the upper frame 10, and a second portion 52 of the insulator 5 is longer than a first portion 51 of the insulator 5, the first portion 51 being located on one side in the extension direction with respect to the battery post 42, the second portion 52 being located on another side in the extension direction with respect to the battery post 42.

In this configuration, by placing a fastener such as a nut as a target of attachment/detachment work with a tool on the other side in the extension direction with respect to the battery post 42, it is possible to perform work such as replacement work of the battery 4 while avoiding or reducing a short circuit via the tool.

### Aspect 13

In the utility vehicle 100 of any one of Aspects 1 to 12, the another side in the extension direction is an outer side in a vehicle width direction.

In maintenance of the battery 4, the user often performs work from the outer side in the vehicle width direction. In this configuration, the user can perform work such as replacement work of the battery 4 while clearly observing the fastener such as the nut.

### Aspect 14

In the utility vehicle 100 of any one of Aspect 1 to 13, the insulator 5 extends along an extension direction of the upper frame 10, includes a first attachment portion (through hole 55h) and a second attachment portion (engagement piece 56), the first attachment portion being located on one side in the extension direction with respect to the battery post 42, the second attachment portion being located on another side in the extension direction with respect to the battery post 42, and is attached to the upper frame 10 via the first attachment portion and the second attachment portion.

This configuration allows the user to perform removal work of the insulator 5 while keeping the tool away from the battery post 42 during work such as removal work of the insulator 5 using a tool in maintenance of the insulator 5, for example. Consequently, a short circuit caused by contact of the tool with the battery post 42 can be prevented or reduced.

### Aspect 15

In the utility vehicle 100 of any one of Aspects 1 to 14, the insulator 5 is attached to a front surface of the upper frame 10 via the first attachment portion and the second attachment portion.

When the tool tilts rearward from the position of the positive post 46, the tool is likely to contact the front surface of the upper frame 10. In this configuration, since the insulator 5 is attached to the front surface of the upper frame 10, contact between the tool and the front surface of the upper frame 10 can be effectively prevented or reduced.

### Aspect 16

The utility vehicle 100 of any one of Aspects 1 to 15 further includes a battery terminal 6 connected to an end portion of a first cable 71 and attached to the battery post 42, the battery terminal 6 includes an attachment hole 6h to which a second cable 72 is attached, and an axis C of the attachment hole 6h extends in a top-bottom direction.

In this configuration, the user can easily perform the attachment/detachment work of the second cable 72 on the battery terminal 6 from above.

What is claimed is:

1. An off-road vehicle comprising:
a seat located on a floor;
a battery located on the floor;
a body frame including an upper frame, the upper frame being located above the battery; and
an insulator located between the upper frame and a battery post of the battery.

2. The off-road vehicle according to claim 1, wherein
the battery is located below the seat, and
the upper frame is at least a portion of a seat frame supporting the seat.

3. The off-road vehicle according to claim 1, wherein
the insulator is attached to the upper frame.

4. The off-road vehicle according to claim 1, wherein
the battery post is offset from the upper frame in a plan view, and
the insulator is located between the upper frame and the battery post in a plan view.

5. The off-road vehicle according to claim 4, wherein
the battery post is offset forward or rearward from the upper frame in a plan view.

6. The off-road vehicle according to claim 5, wherein
the battery post includes a negative post and a positive post, the negative post serving as a negative terminal of the battery, the positive post serving as a positive terminal of the battery,
the upper frame is located between the negative post and the positive post in a plan view, and
the insulator is located between the positive post and the upper frame.

7. The off-road vehicle according to claim 6, wherein
the positive post is offset forward from the upper frame in a plan view,
the negative post is offset rearward from the upper frame in a plan view, and
at least a portion of the insulator is located forward of the upper frame in a plan view.

8. The off-road vehicle according to claim 7, wherein
a height position of an upper end of the insulator is higher than a height position of an upper end of the upper frame, and
a height position of a lower end of the insulator is lower than a height position of a lower end of the upper frame.

9. The off-road vehicle according to claim 4, wherein
a height position of an upper end of the battery post is lower than a height position of a lower end of the upper frame.

10. The off-road vehicle according to claim 4, wherein
the insulator includes a recess that is recessed from the battery post toward the upper frame in a plan view.

11. The off-road vehicle according to claim 10, wherein the recess is recessed in an arc shape in a plan view.

12. The off-road vehicle according to claim 4, wherein
the insulator extends along an extension direction of the upper frame, and
a second portion of the insulator is longer than a first portion of the insulator, the first portion being located on one side in the extension direction with respect to the battery post, the second portion being located on another side in the extension direction with respect to the battery post.

13. The off-road vehicle according to claim 12, wherein
the another side in the extension direction is an outer side in a vehicle width direction.

14. The off-road vehicle according to claim 4, wherein
the insulator
extends along an extension direction of the upper frame,
includes a first attachment portion and a second attachment portion, the first attachment portion being located on one side in the extension direction with respect to the battery post, the second attachment portion being located on another side in the extension direction with respect to the battery post, and
is attached to the upper frame via the first attachment portion and the second attachment portion.

15. The off-road vehicle according to claim 14, wherein
the insulator is attached to a front surface of the upper frame via the first attachment portion and the second attachment portion.

16. The off-road vehicle according to claim 4, further comprising
a battery terminal connected to an end portion of a first cable and attached to the battery post, wherein
the battery terminal includes an attachment hole to which a second cable is attached, and
an axis of the attachment hole extends in a top-bottom direction.
